(19) United States
(12) Patent Application Publication
(10) Pub. No.: US 2025/0317963 A1
(43) Pub. Date: Oct. 9, 2025

(54) METHOD FOR DETERMINING CHANNEL ACCESS PRIORITY CLASSES, AND DEVICE AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN)

(21) Appl. No.: 19/239,903

(22) Filed: Jun. 16, 2025

Related U.S. Application Data
(63) Continuation of application No. PCT/CN2022/140017, filed on Dec. 19, 2022.

(51) Int. Cl. H04W 74/04; H04L 47/24

(52) U.S. Cl. CPC H04W 74/04; H04L 47/24

(57) ABSTRACT

A method for determining channel access priority classes (CAPCs) is provided in the present disclosure. The method is applicable to a terminal, and the method includes: determining a CAPC of a first non-standard quality of service (QOS) flow. The first non-standard QoS flow is different from a standard QoS flow, that is, the first non-standard QoS flow is not defined by communication protocols.

### CROSS-REFERENCE TO RELATED APPLICATION

This application is a continuation of International Application No. PCT/CN2022/140017, filed Dec. 19, 2022, the entire disclosure of which is incorporated herein by reference.

### TECHNICAL FIELD

Embodiments of the present disclosure relate to the technical field of communications, and in particular, relate to a method for determining channel access priority classes (CAPCs), and a device and a non-transitory computer-readable storage medium thereof.

### RELATED ART

In sidelink communication between user equipments (UEs), the UE needs to perform tasks such as listen before talk (LBT) monitoring, packet assembly, and the like based on a CAPC of a radio bearer (RB).

### SUMMARY

Embodiments of the present disclosure provides a method for determining CAPCs, and a device and a non-transitory computer-readable storage medium thereof. The technical solutions at least include the following contents.

According to an aspect of the present disclosure, a method for determining CAPCs is provided. The method is applicable to a terminal. The method includes: determining a CAPC of a first non-standard QoS flow.

According to another aspect of the present disclosure, a communication device is provided. The communication device includes: a processor; a transceiver connected to the processor; and a memory, configured to store one or more executable instructions of the processor, wherein the processor is configured to load the one or more executable instructions to perform the method for determining CAPCs as described above.

According to another aspect of the present disclosure, a non-transitory computer-readable storage medium is provided. The non-transitory computer-readable storage medium stores at least one instruction, at least one segment of a program, a code set, or a set of instructions, wherein the at least one instruction, the at least one segment of a program, the code set, or the set of instructions is loaded by and executed by a processor to perform a method for determining CAPCs as described above.

### BRIEF DESCRIPTION OF DRAWINGS

For clearer descriptions of the technical solutions in embodiments of the present disclosure, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a data transmission system according to some embodiments of the present disclosure;

FIG. 2 is a flowchart of a method for determining CAPCs according to some embodiments of the present disclosure;

FIG. 3 is a flowchart of a method for determining CAPCs according to some embodiments of the present disclosure;

FIG. 4 is a flowchart of a method for determining CAPCs according to some embodiments of the present disclosure;

FIG. 5 is a flowchart of a method for determining CAPCs according to some embodiments of the present disclosure;

FIG. 6 is a flowchart of a method for determining CAPCs according to some embodiments of the present disclosure;

FIG. 7 is a flowchart of a method for determining CAPCs according to some embodiments of the present disclosure;

FIG. 8 is a schematic diagram of a method for determining CAPC according to some embodiments of the present disclosure;

FIG. 9 is a block diagram of an apparatus for determining CAPCs according to some embodiments of the present disclosure; and

FIG. 10 is a structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

Embodiments are described in detail herein, and examples of which are illustrated in the accompanying drawings. When the following description refers to the accompanying drawings, the same numbers in different accompanying drawings represent the same or similar elements unless otherwise indicated. The embodiments described in the following embodiments do not represent all embodiments consistent with the present disclosure. Rather, they are merely examples of apparatus and methods consistent with some aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be noted that the user information (including, but not limited to, user device information, user personal information, or the like) and data (including, but not limited to, data used for analysis, stored data, displayed data, or the like) involved in the present disclosure are authorized by the user or fully authorized by all the parties, and the collection, use and processing of the relevant data need to comply with relevant laws and regulations and standards of the relevant countries and regions.

It should be understood that although the terms “first,” “second,” or the like may be used herein to describe various information, such information should not be limited to these terms. These terms are only used to distinguish one type of information from another. For example, a first parameter may also be referred to as a second parameter, and similarly, a second parameter may also be referred to as a first parameter, without departing from the scope of the present disclosure. The word “if” as used herein, may be interpreted as “in the case that,” “in a case where,” or “in response to determining that,” depending on the context.

Some key terms used in the present disclosure are briefly explained hereinafter.

Standard QoS flow: a QoS flow defined in communication protocols.

Non-Standard QoS flow: Different from the standard QoS flow, a non-standard QoS flow is not defined by communication protocols.

For a UE with standard quality of service (QOS) flows, the network may provide a relevant CAPC, and the UE performs tasks based on the relevant CAPC.

However, for a UE with non-standard QoS flows, the UE may not perform tasks because the network does not know the non-standard QoS flows and fails to provide the relevant CAPC.

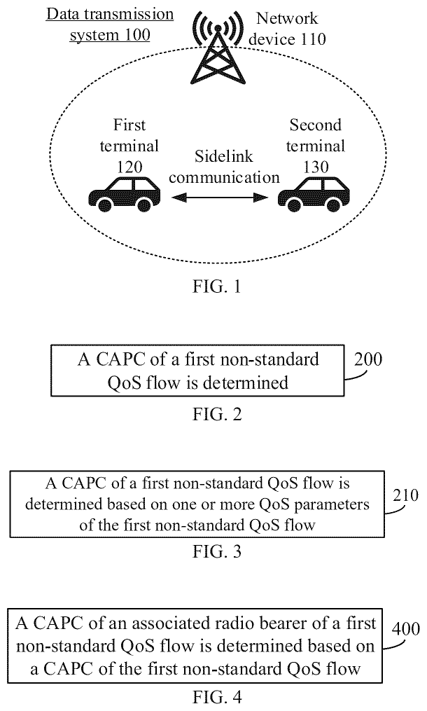

FIG. 1 is a schematic diagram of a data transmission system 100 according to some embodiments of the present disclosure. The data transmission system 100 includes a network device 110, a first terminal 120, and a second terminal 130.

The network device 110 may be a base station, which is a device that provides wireless communication functions for the first terminal 120 and the second terminal 130. The base station may include various forms of macro base stations, micro base stations, relay stations, access points, or the like. In systems using different wireless access technologies, the name of the device having the function of a base station may be different. For example, in a long-term evolution (LTE) system, the device is referred to as an evolved base station (eNodeB, eNB); and in a 5th generation new radio (5G NR) system, the device is referred to as a next-generation base station (gNB). As the communication technology evolves, the description of “base station” may change. For ease of the description in the present disclosure, the above-mentioned devices providing wireless communication functions for the first terminal 120 and the second terminal 130 are collectively referred to as the network device 110.

The first terminal 120 and the second terminal 130 include a variety of handheld devices, in-vehicle devices, wearable devices, computing devices, or other processing devices connected to a wireless modem with wireless communication functions, as well as various forms of user equipments, mobile stations (MSs), terminal devices, or the like.

Device-to-device communication is a sidelink transmission technology based on device-to-device (D2D). Different from the way that communication data in the traditional cellular system is received or transmitted over the base station, an Internet of vehicle (IoV) system adopts a terminal-to-terminal direct communication, such that spectral efficiency is higher and transmission delay is shorter. In the 3rd Generation Partnership Project (3GPP), two transmission modes are defined: Mode A and Mode B.
Mode A: A transmission resource of the terminal is assigned by the base station, and the terminal transmits data on the sidelink based on the resource assigned by the base station. The base station assigns the resource to the terminal for single transmission, or assigned the resource to for the terminal for semi-static transmission.
Mode B: The terminal acquires a group of available transmission resources from a resource pool by means of monitoring, and the terminal randomly selects one resource from the acquired group of resources to transmit sidelink data. Due to periodicity of services in the IoV system, the terminal usually adopts the semi-static transmission manner, i.e., subsequent to selecting one transmission resource, the terminal may continuously use this resource in a plurality of transmission periods, thereby reducing the probability of resource reselection and resource collision.

In the present disclosure, the first terminal 120 and the second terminal 130 performing sideline transmission over mode B is taken as an example for illustration. The “5G NR system” in the present disclosure may also be referred to as a 5G system or an NR system, which may be understood by a person skilled in the art. The technical solutions according to the embodiments of the present disclosure may be applicable to a 5G NR system, and may also be applicable to a subsequently evolved system of the 5G NR system.

FIG. 2 is a flowchart of a method for determining CAPCs according to some embodiments of the present disclosure. The method is applicable to a terminal. The method includes the following process.

In process 200, a CAPC of a first non-standard QoS flow is determined.

When sidelink communication is performed in an unlicensed spectrum, a UE needs to perform LBT monitoring, packet assembly, or other operations based on the CAPC. For a UE in a non-connected state, a non-standard QoS flow may present, wherein the non-connected state includes at least one of an idle state, an inactive state, or an out-of-coverage state. The first non-standard QoS flow is taken as an example for illustration in these embodiments.

Because the network is not aware of the first non-standard QoS flow, the UE fails to acquire the CAPC of the first non-standard QoS flow, and thus needs to determine the CAPC of the first non-standard QoS flow.

The CAPC of the first non-standard QoS flow is determined in at least one of the following ways:
1. determining the CAPC of the first non-standard QoS flow based on one or more QoS parameters of the first non-standard QoS flow;
2. determining the CAPC of the first non-standard QoS flow based on information configured by the network for the first non-standard QoS flow; or in
3. determining the CAPC of the first non-standard QoS flow based on implementation of the terminal.

In some embodiments, the CAPC of the first non-standard QoS flow is determined based on one or more QoS parameters of the first non-standard QoS flow.

The QOS parameter includes at least one of a packet delay budget (PDB), a default priority (DP), a packet error rate (PER), a service type, or a resource type.

For example, the CAPC of the first non-standard QoS flow is determined based on all QoS parameters of the first non-standard QoS flow.

For example, the CAPC of the first non-standard QoS flow is determined based on some of the QoS parameters of the first non-standard QoS flow, wherein the some of the QoS parameters are determined by at least one of network device configuration, autonomous selection by the terminal, or communication protocol definition.

In some embodiments, the CAPC of the first non-standard QoS flow is determined as 1 based on a CAPC corresponding to all QoS parameters of the first non-standard QoS flow being 1.

In some embodiments, the CAPC of the first non-standard QoS flow is determined based on information configured by the network for the first non-standard QoS flow.

The information configured by the network for the first nonstandard QoS flow includes at least one of:
1. a QOS parameter used when determining the CAPC of the first non-standard QoS flow; or
2. a matching criterion for filtering a QoS parameter corresponding to a first CAPC.

The matching criterion includes a parameter matching criterion corresponding to each of the plurality of QOS parameters, wherein the parameter matching criterion includes at least one of:
1. a value of a QOS parameter matching a target value;
2. a value of a QoS parameter belonging to a target value range;
3. a value type of a QoS parameter belonging to a target type; or
4. a level which a value of a QOS parameter is closest to in different levels, wherein the different levels correspond to different CAPCs, and the closest level is a value of a standard QoS flow.

In some embodiments, a CAPC corresponding to the level which the value of the QoS parameter is closest to in the different levels is two, and the CAPC of the first non-standard QoS flow is determined as 2.

In some embodiments, the CAPC of the first non-standard QoS flow is determined based on the implementation of the terminal.

The terminal determines the CAPC of the first non-standard QoS flow based on a matching criterion defined by the terminal, wherein the matching criterion is used to filter a QoS parameter corresponding to a first CAPC, and the matching criterion includes a parameter matching criterion corresponding to each of the plurality of QoS parameters.

In some embodiments, in a case where the terminal defines by itself that the value type of the QoS parameter belongs to the target type, a CAPC corresponding to the QoS parameter is 3, and the CAPC of the first non-standard QoS flow is determined as 3.

In some embodiments, the network provides the CAPC, while allowing the terminal to ignore the CAPC provided by the network and determine the CAPC based on the method described above, wherein the allowance includes at least one of standard default allowance or allowance indicated by the network.

In summary, by using the method according to these embodiments, the terminal determines the CAPC of the first non-standard QoS flow based on the QOS parameters of the first non-standard QoS flow in a case where the network does not provide the CAPC, such that tasks such as LBT monitoring, packet assembly, and the like are performed.

By using the method according to these embodiments, the terminal also determines the CAPC of the first non-standard QoS flow based on information configured by the network for the first non-standard QoS flow in a case where the network does not provide the CAPC, such that tasks such as LBT monitoring, packet assembly, and the like are performed.

By using the method according to these embodiments, the terminal also determines the CAPC of the first non-standard QoS flow based on the implementation of the terminal in a case where the network does not provide the CAPC, such that tasks such as LBT monitoring, packet assembly, and the like are performed.

FIG. 3 is a flowchart of a method for determining CAPCs according to some embodiments of the present disclosure. The method is applicable to a terminal. The method includes the following process.

In process 210, a CAPC of a first non-standard QoS flow is determined based on one or more QoS parameters of the first non-standard QoS flow.

The one or more QoS parameters of the first non-standard QoS flow include at least one of a PDB, a DP, a PER, a service type, or a resource type.

The PDB defines an upper limit of a possible delay subsequent to transmitting the packet; the DP is a priority parameter predefined by the system; and the PER is a value acquired by dividing the number of packets received with error by the total number of received packets.

The one or more QOS parameters used in determining the CAPC of the first non-standard QoS flow are determined or selected in at least one of the following manners:
network device configuration;
a communication protocol provision;
service type-based selection; or
resource type-based selection.

In some embodiments, the CAPC of the first non-standard QoS flow is determined based on a parameter matching criterion satisfied by one QoS parameter of the first non-standard QoS flow.

In some embodiments, the CAPC of the first non-standard QoS flow is determined based on the number of parameters in the plurality of QoS parameters of the first non-standard QoS flow that satisfy a matching criterion, wherein the matching criterion is used to filter a QoS parameter corresponding to a first CAPC; and the matching criterion includes a parameter matching criterion corresponding to each of the plurality of QoS parameters.

The parameter matching criterion includes at least one of:
(1) a value matching a target value;
(2) a value belonging to a target value range;
(3) a value type belonging to a target type; or
(4) a level which a value is closest to in different levels, wherein the different levels correspond to different CAPCs.

At least one of the target value, the target value range, the target type, or the level is determined by at least one of: a network device configuration, or a communication protocol provision.

The network device configuration is implemented in at least one of the following manners.
(1) The network device configuration is implemented over dedicated radio resource control (RRC).
(2) The network device configuration is implemented over a system information block (SIB).
(3) The network device configuration is implemented by pre-configuration.

### The Value Matching the Target Value

The case where the one or more QoS parameter values match the target value includes at least one of the following cases.

A value of the PDB matches the target value in a case where the one or more QoS parameters include the PDB.

A value of the DP matches the target value in a case where the one or more QoS parameters include the DP.

A value of the PER matches the target value in a case where the one or more QoS parameters include the PER.

In some embodiments, as illustrated in Table 1, the CAPC of the first non-standard QoS flow is determined in a case where the one or more QoS parameters include the DP, and the value of the DP matches the target value. In a case where the DP takes a value of 1, the CAPC takes the value of 1; in a case where the DP takes a value of 2, the CAPC takes the value of 2; or in a case where the DP takes a value of 3, the CAPC takes the value of 3.

TABLE 1

| DP | CAPC |
|---|---|
| 1 | 1 |
| 2 | 2 |
| 3 | 3 |

### The Value Belonging to the Target Value Range

The case where the one or more QoS parameter values belong to the target value range include at least one of the following cases.

A value of the PDB belongs to the target value range in a case where the one or more QoS parameters include the PDB.

A value of the PER belongs to the target value range in a case where the one or more QoS parameters include the PER.

Different target value ranges correspond to different CAPCs, and the target value ranges corresponding to the CAPCs are specified by network device configuration or communication protocols.

In some embodiments, as illustrated in Table 2, the CAPC of the first non-standard QoS flow is determined in a case where the one or more QoS parameters include the PDB, and the value of the PDB belongs to the target value range.

In a case where a value range of the PDB is 0 to 100 ms, a corresponding CAPC takes a value of 1; in a case where a value range of the PDB is 100 to 200 ms, a corresponding CAPC takes a value of 2; or in a case where a value range of the PDB is 200 to 300 ms, a corresponding CAPC takes a value of 3. In a case where the PDB takes a value of 100 ms, the corresponding CAPC takes the value of 1; or in a case where the PDB takes a value of 200 ms, the corresponding CAPC takes the value of 2. In a case where the PDB takes a value of 50 ms, which is within the value range corresponding to CAPC taking the value of 1, the CAPC of the first non-standard QoS flow is determined as 1.

TABLE 2

| | |
|---|---|
| PDB | CAPC |

| | | |
|---|---|---|
| 0 to 100 | ms | 1 |
| 100 to 200 | ms | 2 |
| 200 to 300 | ms | 3 |

### The Value Type Belonging to the Target Type

The case where the value types of the one or more of the QoS parameters are a particular value type or of a specified value type, i.e. a target type, include at least one of the following cases.

A value type of the service type belongs to the target type in a case where the one or more QoS parameters include the service type.

A value type of the resource type belongs to the target type in a case where the one or more QoS parameters include the resource type.

In some embodiments, as illustrated in Table 3, the value type of the service type is a mission critical service (MCS), a corresponding CAPC takes a value of 1; and the value type of the resource type is a delay critical guaranteed bit rate (DCGBR), and a corresponding CAPC takes a value of 1.

TABLE 3

| Service type | Resource type | CAPC |
|---|---|---|
| MCS | DCGBR | 1 |

The Level which the Value is Closest to in the Different Levels

The case where the values of the one or more QoS parameters are closest to in the different levels include at least one of the following cases.

The level which a value of the PDB is closest to in the different levels in a case where the one or more QoS parameters include the PDB.

The level which a value of the PER is closest to in the different levels in a case where the one or more QoS parameters include the PER.

In some embodiments, as illustrated in Table 4, in a case where the PDB is a first level of 100 ms, a corresponding CAPC takes a value of 1; in a case where the PDB is a second level of 200 ms, a corresponding CAPC takes a value of 2; and in a case where the PDB is a third level of 300 ms, a corresponding CAPC takes a value of 3. In a case where the PDB takes a value of 120 ms, a difference between the PDB and the first level of 100 ms is 20 ms, and a difference between the PDB and the second level of 200 ms is 80 ms, which is greater than 20 ms, such that the CAPC of the first non-standard QoS flow is determined to be the CAPC corresponding to the closest first level of 100 ms.

TABLE 4

| PDB | CAPC |
|---|---|
| 100 ms | 1 |
| 200 ms | 2 |
| 300 ms | 3 |

In some embodiments, determining the CAPC of the first non-standard QoS flow based on the number of parameters in the plurality of QoS parameters of the first non-standard QoS flow that satisfy the matching criterion includes at least one of:
(1) determining the CAPC of the first non-standard QoS flow as the first CAPC in a case where the plurality of QOS parameters all satisfy the matching criterion; or
(2) determining the CAPC of the first non-standard QoS flow as the first CAPC in a case where the number of parameters in the plurality of QoS parameters that satisfy the matching criterion reaches a first number.

### The Plurality of QOS Parameters all Satisfy the Matching Criterion

In some embodiments, as illustrated in Table 5, the plurality of QOS parameters include: a DP and a PDB. In a case where the DP takes a value of 1, a corresponding CAPC takes the value of 1; in a case where a DP takes a value of 2, a corresponding CAPC takes the value of 1; or in a case where a DP takes a value of 3, a corresponding CAPC takes the value of 1.

In a case where a value range of the PDB is 0 to 100 ms, a corresponding CAPC takes a value of 1.

In a case where a value range of the PDB is 100 to 200 ms, a corresponding CAPC takes a value of 2.

In a case where a value range of the PDB is 200 to 300 ms, a corresponding CAPC takes a value of 3.

In a case where the DP takes a value of 1 and the PDB takes a value of 50 ms, both the DP and the PDB satisfy the matching criteria, and the CAPC of the first non-standard QoS flow is determined as 1.

TABLE 5

| | | |
|---|---|---|
| DP | PDB | CAPC |

| | | | |
|---|---|---|---|
| 1 | 0 to 100 | ms | 1 |
| 2 | 100 to 200 | ms | 2 |
| 3 | 200 to 300 | ms | 3 |

The Number of Parameters in the Plurality of QoS Parameters that Satisfy the Matching Criterion Reaches the First Number

In some embodiments, the first CAPC of the first non-standard QoS flow is determined as the first CAPC in a case where the number of parameters in the plurality of QoS parameters that satisfy the matching criterion reaches the first number.

In some embodiments, the first number is 2, the first CAPC is 2, and the plurality of QoS parameters include the DP and the PDB. As illustrated in Table 5, in a case where the DP is 2 and the PDB is 150 ms, the number of parameters that satisfy the matching criterion reaches the first number, and the CAPC of the first non-standard QoS flow is determined as 2.

In some embodiments, the first CAPC of the first non-standard QoS flow is determined as the first CAPC in a case where the number of parameters in the plurality of QOS parameters that satisfy the matching criterion is determined as reaching the first number based on priorities wherein the priorities indicate a determination order of the plurality of QoS parameters. The priority is specified by network device configuration or communication protocols, and the smaller the priority, the higher the ranking of the QoS parameter in the determination order.

In some embodiments, the first number is 2, the first CAPC is 3, and the plurality of QoS parameters include the DP, the PDB, and the PER. The priority of the DP is 1, the priority of the PDB is 2, and the priority of the PER is 3. As illustrated in Table 5, in a case where the first non-standard QoS flow with the DP is 3 and the PDB is 250 ms, the number of parameters in the plurality of QOS parameters that satisfy the matching criterion is determined as reaching the first number based on the priority, and the CAPC of the first non-standard QoS flow is determined as 3.

The state of the terminal when the terminal performs the above method includes at least one of an RRC connected state, an RRC idle state, an RRC inactive state, or an out-of-coverage state.

In summary, by using the method according to these embodiments, the terminal determines the CAPC of the first non-standard QoS flow based on one or more QoS parameters of the first non-standard QoS flow, in a case where the network does not provide the CAPC, such that tasks such as LBT monitoring, packet assembly, and the like are performed.

FIG. 4 is a flowchart of a method for determining CAPCs according to some embodiments of the present disclosure. The method is applicable to a terminal. The method including the following process.

In process 400, a CAPC of an associated radio bearer of a first non-standard QoS flow is determined based on a CAPC of the first non-standard QoS flow.

By determining the CAPC of the first non-standard QoS flow, a CAPC configuration of a mapped associated radio bearer is further acquired, which is determined by the method of determining the CAPC in the above embodiments. The associated radio bearer is a specific radio bearer, including a default radio bearer.

In a case where only the CAPC of the first non-standard QoS flow is present, the CAPC of the associated radio bearer of the first non-standard QoS flow is determined as the CAPC of the first non-standard QoS flow.

In some embodiments, in a case where the network device configures the CAPC of the associated radio bearer, the network device may instruct the UE to use the CAPC configured by the network device; or instruct the UE to autonomously determine the CAPC of the radio bearer based on the CAPC of the non-standard QoS flow; or the UE may by default ignore the CAPC configured by the network device and autonomously determine the CAPC of the radio bearer.

In summary, by using the method according to these embodiments, the terminal determines the CAPC of the associated radio bearer of the first non-standard QoS flow based on the CAPC of the first non-standard QoS flow, in a case where the network does not provide the CAPC, such that tasks such as LBT monitoring, packet assembly, and the like are performed.

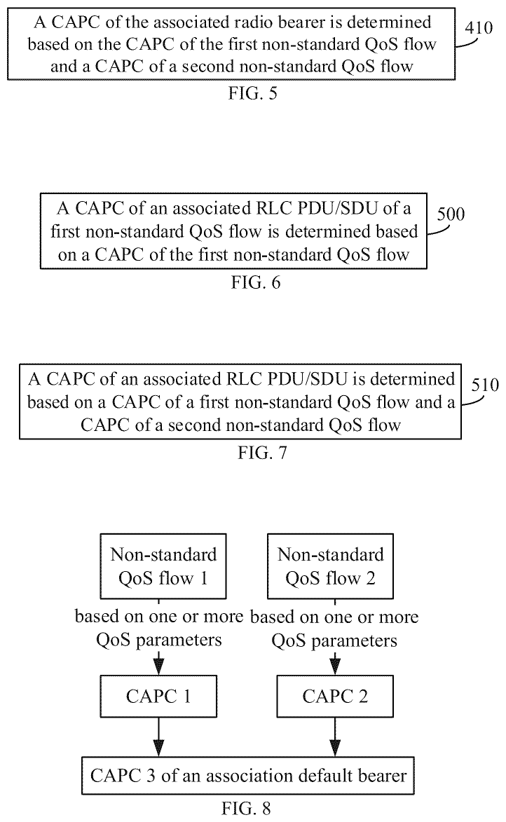

FIG. 5 is a flowchart of a method for determining CAPCs according to some embodiments of the present disclosure. The method is applicable to a terminal. The method including the following process.

In process 410, a CAPC of the associated radio bearer is determined based on the CAPC of the first non-standard QoS flow and a CAPC of a second non-standard QoS flow.

In a case where the CAPC of the first non-standard QoS flow and the CAPC of the second non-standard QoS flow are present, the CAPC of the associated radio bearer is determined to be one of the two CAPCs based on a specific rule, wherein the associated radio bearer is a radio bearer that is associated with the first non-standard QoS flow and the second non-standard QoS flow.

Determining the CAPC of the associated radio bearer based on the CAPC of the first non-standard QoS flow and the CAPC of the second non-standard QoS flow includes at least one of:
determining a maximum value in the CAPC of the first non-standard QoS flow and the CAPC of the second non-standard QoS flow as the CAPC of the associated radio bearer;
determining a minimum value in the CAPC of the first non-standard QoS flow and the CAPC of the second non-standard QoS flow as the CAPC of the associated radio bearer;
determining any one of the CAPC of the first non-standard QoS flow and the CAPC of the second non-standard QoS flow as the CAPC of the associated radio bearer; or
determining an average value of the CAPC of the first non-standard QoS flow and the CAPC of the second non-standard QoS flow as the CAPC of the associated radio bearer.
(1) The maximum value in the CAPC of the first non-standard QoS flow and the CAPC of the second non-standard QoS flow is determined as the CAPC of the associated radio bearer.

In a case where the CAPC of the first non-standard QoS flow and the CAPC of the second non-standard QoS flow are present, the maximum value in the two CAPCs is determined as the CAPC of the associated radio bearer, wherein the maximum value corresponds to the minimum priority.

For example, the two CAPCs are CAPC 1 and CAPC 2, wherein CAPC 1 takes a value of 1 and CAPC 2 takes a value of 2. The value of CAPC 2 is maximum, then the value of the CAPC of the associated radio bearer is determined as 2.
(2) The minimum value in the CAPC of the first non-standard QoS flow and the CAPC of the second non-standard QoS flow is determined as the CAPC of the associated radio bearer.

In a case where the CAPC of the first non-standard QoS flow and the CAPC of the second non-standard QoS flow are present, the minimum value in the two CAPCs is determined as the CAPC of the associated radio bearer, wherein the minimum value corresponds to the maximum priority.

For example, the two CAPCs are CAPC 1 and CAPC 2, wherein CAPC 1 takes a value of 1 and CAPC 2 takes a value of 2. The value of CAPC 1 is minimum, and the value of the CAPC of the associated radio bearer is determined as 1.
(3) Any one of the CAPC of the first non-standard QoS flow and the CAPC of the second non-standard QoS flow is determined as the CAPC of the associated radio bearer.

In a case where the CAPC of the first non-standard QoS flow and the CAPC of the second non-standard QoS flow are present, any one of the two CAPCs is determined as the CAPC of the associated radio bearer.

For example, the two CAPCs are CAPC 1 and CAPC 2, wherein CAPC 1 takes a value of 1 and CAPC 2 takes a value of 2, and the value of the CAPC of the associated radio bearer is determined as 1 or 2.
(4) The average value of the CAPC of the first non-standard QoS flow and the CAPC of the second non-standard QoS flow is determined as the CAPC of the associated radio bearer.

In a case where the CAPC of the first non-standard QoS flow and the CAPC of the second non-standard QoS flow are present, the average value of the two CAPCs is determined as the CAPC of the associated radio bearer, wherein the average value can be rounded up or down.

For example, the two CAPCs are CAPC 1 and CAPC 2, wherein CAPC 1 takes a value of 1 and CAPC 2 takes a value of 2. An average value of the values of CAPC 1 and CAPC 2 is 2, and a rounded-down average value of the values of CAPC 1 and CAPC 2 is 1. In a case where the value of the CAPC of the associated radio bearer is determined as the rounded-up average value, the CAPC of the associated radio bearer takes the value of 2; or in a case where the value of the CAPC of the associated radio bearer is determined as the rounded-down average value, the CAPC of the associated radio bearer takes the value of 1.
(5) In some embodiments, the QOS parameter of the first non-standard QoS flow includes a first parameter, and a QoS parameter of the second non-standard QoS flow includes the first parameter.

In a case where the first parameter corresponding to the first non-standard QoS flow is minimum, the CAPC of the first non-standard QoS flow is determined as the CAPC of the associated radio bearer.

In a case where the first parameter corresponding to the second non-standard QoS flow is minimum, the CAPC of the second non-standard QoS flow is determined as the CAPC of the associated radio bearer.

The first parameter includes at least one of the PDB, the DP, or the PER.

For example, the DP in the QoS parameter of the first non-standard QoS flow takes a value of 1, the DP in the QOS parameter of the second non-standard QoS flow takes a value of 2, and 1 is less than 2. Therefore, the CAPC of the associated radio bearer is the CAPC of the first non-standard QoS flow.
(6) In some embodiments, the QOS parameter of the first non-standard QoS flow includes a second parameter, and the QoS parameter of the second non-standard QoS flow includes the second parameter.

In a case where the second parameter corresponding to the first non-standard QoS flow is of a first type, the CAPC of the first non-standard QoS flow is determined as the CAPC of the associated radio bearer.

In a case where the second parameter corresponding to the second non-standard QoS flow is of the first type, the CAPC of the second non-standard QOS flow is determined as the CAPC of the associated radio bearer.

The second parameter includes at least one of the service type or the resource type.

The first type corresponding to the service type is the MCS, and the first type corresponding to the resource type is the DCGBR.

In some embodiments, in a case where the service type corresponding to the first non-standard QoS flow is the MCS, the CAPC of the associated radio bearer is the CAPC of the first non-standard QoS flow.

In summary, by using the method according to these embodiments, the CAPC of the associated radio bearer is determined based on the CAPC of the first non-standard QoS flow and the CAPC of the second non-standard QoS flow. In a case where the network does not provide the CAPC, the terminal determines the CAPC of the associated radio bearer, such that tasks such as LBT monitoring, packet assembling, and the like are performed.

FIG. 6 is a flowchart of a method for determining CAPCs according to some embodiments of the present disclosure. The method is applicable to a terminal. The method including the following process.

In process 500, a CAPC of an associated radio link control service data unit/protocol data unit (RLC PDU/SDU) of a first non-standard QoS flow is determined based on a CAPC of the first non-standard QoS flow.

The unprocessed data that enters each sublayer is referred to as an SDU, and the data that is processed by the sublayer to form a specific format is referred to as a PDU, and an SDU at an N^{th} layer and a PDU at an (N−1)^{th} layer are one-to-one correspondence.

The CAPC of the first non-standard QoS flow is determined by the method of determining the CAPC of the first non-standard QoS flow in the above embodiments, and the RLC PDU/SDU associated with the non-standard QoS flow is associated with a specific radio bearer, such as a default radio bearer.

The CAPC of the associated RLC PDU/SDU of the first non-standard QoS flow is determined as the CAPC of the first non-standard QoS flow in a case where only the CAPC of the first non-standard QoS flow is present.

In summary, by using the method according to these embodiments, the CAPC of the associated RLC PDU/SDU of the first non-standard QoS flow is determined based on the CAPC of the first non-standard QoS flow. In a case where the network does not provide the CAPC, the terminal determines the CAPC of the associated RLC PDU/SDU of the first non-standard QoS flow, such that tasks such as LBT monitoring, packet assembly, and the like are performed.

FIG. 7 is a flowchart of a method for determining CAPCs according to some embodiments of the present disclosure. The method is applicable to a terminal. The method including the following process.

In process 510, a CAPC of an associated RLC PDU/SDU is determined based on a CAPC of a first non-standard QoS flow and a CAPC of a second non-standard QoS flow.

In a case where the CAPC of the first non-standard QoS flow and the CAPC of the second non-standard QoS flow are present, when the two CAPCs have a same priority, the CAPC of the associated RLC PDU/SDU is determined to be of this same priority, wherein the associated RLC PDU/SDU is an RLC PDU/SDU associated with the first non-standard QoS flow and the second non-standard QoS flow.

For example, CAPC 1 of the first non-standard QoS flow and CAPC 2 of the second non-standard QoS flow have the same priority, and the CAPC of the associated RLC PDU/SDU is determined to be of this same priority.

In a case where the CAPC of the first non-standard QoS flow and the CAPC of the second non-standard QoS flow are present, when the two CAPCs have different priorities, the CAPC of the associated RLC PDU/SDU is determined to be of one of the different priorities based on a specific rule.

The CAPC of the associated RLC PDU/SDU is determined based on the CAPC of the first non-standard QoS flow and the CAPC of the second non-standard QoS flow in at least one of the following manners:
determining a maximum value in the CAPC of the first non-standard QoS flow and the CAPC of the second non-standard QoS flow as the CAPC of the associated RLC PDU/SDU;
determining a minimum value in the CAPC of the first non-standard QoS flow and the CAPC of the second non-standard QoS flow as the CAPC of the associated RLC PDU/SDU;
determining any one of the CAPC of the first non-standard QoS flow and the CAPC of the second non-standard QoS flow as the CAPC of the associated RLC PDU/SDU; and
determining an average value of the CAPC of the first non-standard QoS flow and the CAPC of the second non-standard QoS flow as the CAPC of the associated RLC PDU/SDU.
(1) The maximum value in the CAPC of the first non-standard QoS flow and the CAPC of the second non-standard QoS flow is determined as the CAPC of the associated RLC PDU/SDU.

In a case where the CAPC of the first non-standard QoS flow and the CAPC of the second non-standard QoS flow are present, the maximum value in the two CAPCs is determined as the CAPC of the associated RLC PDU/SDU, wherein the maximum value corresponding to the minimum priority.

For example, the two CAPCs are CAPC 1 and CAPC 2, and CAPC 1 takes a value of 1 and CAPC 2 takes a value of 2. The value of CAPC 2 is maximum, and the value of the CAPC of the associated RLC PDU/SDU is determined as 2.
(2) The minimum value in the CAPC of the first non-standard QoS flow and the CAPC of the second non-standard QoS flow is determined as the CAPC of the associated RLC PDU/SDU.

In a case where the CAPC of the first non-standard QoS flow and the CAPC of the second non-standard QoS flow are present, the minimum value in the two CAPCs is determined as the CAPC of the associated RLC PDU/SDU, wherein the minimum value corresponds to the maximum priority.

For example, the two CAPCs are CAPC 1 and CAPC 2, and CAPC 1 takes a value of 1 and CAPC 2 takes a value of 2. The value of CAPC 1 is minimum, and the value of the CAPC the associated RLC PDU/SDU is determined as 1.
(3) Any one of the CAPC of the first non-standard QoS flow and the CAPC of the second non-standard QoS flow is determined as the CAPC of the associated RLC PDU/SDU.

In a case where the CAPC of the first non-standard QoS flow and the CAPC of the second non-standard QoS flow are present, any one of the two CAPCs is determined as the CAPC of the associated RLC PDU/SDU.

For example, the two CAPCs are CAPC 1 and CAPC 2, wherein CAPC 1 takes a value of 1 and CAPC 2 takes a value of 2, and the value of the CAPC of the associated RLC PDU/SDU is determined as 1 or 2.
(4) The average value of the CAPC of the first non-standard QoS flow and the CAPC of the second non-standard QoS flow is determined as the CAPC of the associated RLC PDU/SDU.

In a case where the CAPC of the first non-standard QoS flow and the CAPC of the second non-standard QoS flow are present, the average value of the two CAPCs is determined as the CAPC of the associated RLC PDU/SDU, wherein the average value may be rounded up or down.

For example, the two CAPCs are CAPC 1 and CAPC 2, and CAPC 1 takes a value of 1 and CAPC 2 takes a value of 2. The rounded-up average value of the values of CAPC 1 and CAPC 2 is 2, and the rounded-down average value of the values of CAPC 1 and CAPC 2 is 1. In a case where the CAPC of the associated RLC PDU/SDU is determined as the rounded-up average value, the CAPC of the associated RLC PDU/SDU takes the value of 2; or in a case where the CAPC of the associated RLC PDU/SDU is determined as the rounded-down average value, the CAPC of the associated RLC PDU/SDU takes the value of 1.
(5) In some embodiments, the QOS parameter of the first non-standard QoS flow includes a third parameter, and the QoS parameter of the second non-standard QoS flow includes the third parameter.

In a case where the third parameter corresponding to the first non-standard QoS flow is minimum, the CAPC of the first non-standard QoS flow is determined as the CAPC of the associated RLC PDU/SDU.

In a case where the third parameter corresponding to the second non-standard QoS flow is minimum, the CAPC of the second non-standard QoS flow is determined as the CAPC of the associated RLC PDU/SDU.

The third parameter includes at least one of the PDB, the DP, or the PER.

For example, the DP in the QoS parameter of the first non-standard QoS flow takes a value of 1, the DP in the QOS parameter of the second non-standard QoS flow takes a value of 2, and 1 is less than 2. Therefore, the CAPC of the associated RLC PDU/SDU is the CAPC of the first non-standard QoS flow.
(6) In some embodiments, the QoS parameter of the first non-standard QoS flow includes a fourth parameter, and the QoS parameter of the second non-standard QoS flow includes the fourth parameter.

In a case where the fourth parameter corresponding to the first non-standard QoS flow is of a second type, the CAPC of the first non-standard QoS flow is determined as the CAPC of the associated RLC PDU/SDU.

In a case where the fourth parameter corresponding to the second non-standard QoS flow is of the second type, the CAPC of the second non-standard QoS flow is determined as the CAPC of the associated RLC PDU/SDU.

The fourth parameter includes at least one of the service type or the resource type.

The second type corresponding to the service type is the MCS, and the second type corresponding to the resource type is the DCGBR.

In some embodiments, in a case where the service type corresponding to the first non-standard QoS flow is the MCS, the CAPC of the associated RLC PDU/SDU is the CAPC of the first non-standard QoS flow.

In some embodiments, the first non-standard QoS flow and the second non-standard QoS flow having a same CAPC are mapped to the same RLC PDU/SDU, and the CAPC of the same RLC PDU/SDU is determined.

In a case where non-standard QoS flows with the same CAPC value are mapped to the same RLC SDU/PDU, the UE determines the CAPC of the RLC SDU/PDU takes a value same as the value of the same CAPC.

For example, the first non-standard QoS flow and the second non-standard QoS flow have the same CAPC value of 1. In a case where the first non-standard QoS flow and the second non-standard QoS flow are mapped to the same RLC SDU/PDU, the UE determines that the CAPC of the same RLC SDU/PDU takes the value of 1.

In some embodiments, the first non-standard QoS flow and the second non-standard QoS flow having similar CAPCs are mapped to the same RLC PDU/SDU, the CAPC of the same RLC PDU/SDU is determined.

Similar CAPCs means that a difference between CAPC values is less than a first range, wherein the first range is specified by the network device configuration or communication protocols.

In a case where non-standard QoS flows with similar CAPC values are mapped to the same RLC SDU/PDU, the UE determines the CAPC of the RLC SDU/PDU.

For example, the first range takes a value of 2, CAPC 1 of the first non-standard QoS flow takes a value of 1, and CAPC 2 of the second non-standard QoS flow takes a value of 2. In a case where the first non-standard QoS flow and the second non-standard QoS flow are mapped to the same RLC SDU/PDU, the UE determines the CAPC of the same RLC SDU/PDU based on the above described method for determining the CAPC of the associated RLC SDU/PDU.

In summary, by using method according to these embodiments, the terminal determines the CAPC of the associated RLC SDU/PDU based on the CAPC of the first non-standard QoS flow and the CAPC of the second non-standard QoS flow. In a case where the network does not provide the CAPC, the terminal determines determining the CAPC of the associated RLC SDU/PDU, such that tasks of LBT monitoring, packet assembly, and the like are performed.

The above embodiments of determining the CAPC of the first non-standard QoS flow, determining the CAPC of the associated radio bearer, and determining the CAPC of the associated RLC SDU/PDU may be implemented in a free combination of two or three, which are not limited in the present disclosure.

During the sidelink communication, the UE needs to perform task such as LBT monitoring and packet assembly based on a CAPC of a resource block (RB). For a UE with a standard QoS flow, the network provides the relevant CAPC, and the UE performs tasks based on the relevant CAPC. However, for a UE with a non-standard QoS flow, because the network does not know the non-standard QoS flow, the network fails to provide the relevant CAPC, and the UE fails to perform the task. In this regard, the present disclosure provides a method of determining a CAPC for a UE to determine a CAPC of a QoS flow. FIG. 8 is a schematic diagram of a method for determining a CAPC according to some embodiments of the present disclosure. The method is applicable to a terminal, and during the execution of the method, the terminal supports at least one of an RRC connected state, an RRC idle state, an RRC inactive state, or an out-of-coverage state.

For the UE with one or more non-standard QoS flows, using existence of both non-standard QoS flow 1 and non-standard QoS flow 2 as an example, non-standard QoS flow 1 is explained hereinafter.

The UE determines CAPC 1 based on one or more QoS parameters in non-standard QoS flow 1, wherein the one or more QOS parameters include at least one of the PDB, the DP, the PER, the service type, or the resource type.

The one or more QoS parameters are specified by the network device configuration or the communication protocols. The network device configuration is implemented over dedicated RRC or a SIB or pre-configuration. The dedicated RRC refers to UE-specific RRC.

The one or more QOS parameters have priorities, wherein the priorities of different QoS parameters are specified by the network device configuration or communication protocol provisions. The network device configuration is specified over the dedicated RRC or the SIB or pre-configuration, and the smaller the priorities, the higher the rankings of the QoS parameters in the determination order.

Parameter matching criteria include at least one of a value matching the target value, a value belonging to the target range, a value type belonging to the target type, or a level which a value is closest to in different levels, wherein the different levels correspond to different CAPCs.

(1) the Value Matching with the Target Value

The case where the values of the one or more QoS parameters match the target values includes at least one of the following cases.

The value of the PDB matches the target value in a case where the one or more QoS parameters include the PDB.

The value of the DP matches the target value in a case where the one or more QoS parameters include the DP.

The value of the PER matches the target value in a case where the one or more QoS parameters include the PER.

For example, as illustrated in Table I, in a case where the one or more of the QoS parameters include the DP, the value of the DP matches the target value, and CAPC 1 of non-standard QoS flow 1 is determined. In a case where the DP takes a value of 1, CAPC 1 takes the value of 1; or in a case where the DP takes a value of 2, CAPC 1 takes the value of 2; and in a case where the DP takes a value of 3, CAPC 1 takes the value of 3.

### (2) the Value Belonging to the Target Value Range

The case where the values of the one or more QoS parameters belong to the target value range includes at least one of the following cases.

The value of the PDB belongs to the target value range in a case where the one or more QOS parameters include the PDB.

The value of the PER belongs to the target value range in a case where the one or more QOS parameters include the PER.

Different target value ranges correspond to different CAPCs, and the target value ranges corresponding to the CAPCs are specified by network device configuration or communication protocols.

For example, as illustrated in Table 2, in a case where the one or more QoS parameters include the PDB, the value of the PDB belongs to the target value range, CAPC 1 of non-standard QoS flow 1 is determined.

In a case where the value range of the PDB is 0 to 100 ms, a corresponding CAPC takes a value of 1; in a case where the value range of the PDB is 100 to 200 ms, a corresponding CAPC takes a value of 2; and in a case where the value range of the PDB is 200 to 300 ms, a corresponding CAPC takes a value of 3. In a case where the PDB takes a value of 100 ms, a corresponding CAPC takes a value of 1; and in a case where the PDB takes a value of 200 ms, a corresponding CAPC takes a value of 2. In a case where the PDB takes a value of 50 ms, which is within the value range corresponding to CAPC taking the value of 1, CAPC 1 of non-standard QoS flow 1 is determined as 1.

### (3) the Value Type Belonging to the Target Type

The case where the types of the values of the one or more of the QoS parameters belong to a particular value type or a specified value type, i.e. belong to the target type, includes at least one of the following cases.

The value type of the service type belongs to the target type in a case where the one or more QoS parameters include the service type.

The value type of the resource type belongs to the target type in a case where the one or more QoS parameters include the resource type.

For example, as illustrated in Table 3, the value type of the service type is the MCS, a corresponding CAPC takes a value of 1; and the value type of the resource type is the DCGBR, a corresponding CAPC takes a value of 1. In a case where the QoS parameters of non-standard QoS flow 1 include the service type, the value type of the service type is the MCS, CAPC 1 of non-standard QoS flow 1 is determined as 1.

(4) the Level which the Value is Closest to in the Different Levels

The case where the level which the values of the one or more QoS parameters is closest to in the different levels include at least one of the following cases.

The level which the value of the PDB is closest to in the different levels in a case where the one or more QoS parameters include the PDB.

The level which the value of the PER is closest to in the different levels in a case where the one or more QoS parameters include the PER.

For example, as illustrated in Table 4, in a case where the PDB is the first level of 100 ms, the corresponding CAPC takes a value of 1; in a case where the PDB is the second level of 200 ms, the corresponding CAPC takes a value of 2; and in a case where the PDB is the third level of 300 ms, the corresponding CAPC takes a value of 3. In a case where the PDB takes a value of 120 ms, a difference between the PDB and the first level of 100 ms is 20 ms, and a difference between the PDB and the second level of 200 ms is 80 ms, which is more than 20 ms, such that CAPC 1 of non-standard QoS flow 1 is determined to be the closest CAPC corresponding to the first level of 100 ms.

In some embodiments, determining CAPC 1 of non-standard QoS flow 1 based on the number of parameters in the plurality of QoS parameters of the first non-standard QoS flow that satisfy a matching criterion includes at least one of:
(1) determining CAPC 1 of non-standard QoS flow 1 as the first CAPC in a case where the plurality of QOS parameters all satisfy the matching criterion; or
(2) determining CAPC 1 of non-standard QoS flow 1 as the first CAPC in a case where the number of parameters in the plurality of QOS parameters that satisfy the matching criterion reaches a first number.

### (1) the Plurality of QoS Parameters all Satisfying the Matching Criterion

In some embodiments, as illustrated in Table 5, the plurality of QOS parameters include the DP and the PDB. In a case where the DP takes a value of 1, a corresponding CAPC takes the value of 1; in a case where the DP takes a value of 2, a corresponding CAPC takes the value of 1; and in a case where the DP takes a value of 3, a corresponding CAPC takes the value of 1.

In a case where the value range of the PDB is 0 to 100 ms, the corresponding CAPC takes a value of 1. In a case where the value range of the PDB is 100 to 200 ms, the corresponding CAPC takes a value of 2. In a case where the value range of the PDB is 200 to 300 ms, the corresponding CAPC takes a value of 3.

In a case where the DP takes a value of 1 and the PDB takes a value of 50 ms, both the DP and the PDB satisfy the matching criterion, and CAPC 1 of non-standard QoS flow 1 is determined as 1.

(2) The Number of Parameters in the Plurality of QoS Parameters that Satisfy the Matching Criterion Reaches the First Number

In some embodiments, CAPC 1 of non-standard QoS flow 1 is determined as the first CAPC in a case where the number of parameters in the plurality of QOS parameters that satisfy the matching criterion reaches the first number.

In some embodiments, the first number is 2, the first CAPC takes a value of 2, and the plurality of QOS parameters include the DP and the PDB. As illustrated in Table 5, in a case where the DP takes a value of 2 and the PDB takes a value of 150 ms, the number of parameters that satisfies the matching criterion reaches the first number, and CAPC 1 of non-standard QoS flow 1 is determined as 2.

In some embodiments, determining CAPC 1 of non-standard QoS flow 1 as the first CAPC in a case where the number of parameters in the plurality of QOS parameters that satisfy the matching criterion reaches the first number based on the priority, wherein the priority indicates the determination order of the plurality of QoS parameters. The priority is specified over the network device configuration or communication protocols, and the smaller the priority, the higher the ranking of the QoS parameter in the determination order.

For example, the first number is two, the first CAPC takes a value of 3, and the plurality of QoS parameters include the DP, the PDB, and the PER. The priority of the DP is 1, the priority of the PDB is 2, and the priority of the PER is 3. As illustrated in Table 5, in a case where the DP in the QoS parameter of the non-standard QoS flow 1 takes a value of 3, and the PDB takes a value of 250 ms, i.e., in a case where the number of parameters that satisfy the matching criterion reaches the first number based on the priority, CAPC 1 of non-standard QoS flow 1 is determined as 3.

Determining CAPC 2 of non-standard QoS flow 2 is the same as determining CAPC 1 of non-standard QoS flow 1 as described above, which is not repeated herein any further.

Subsequent to determining CAPC 1 of non-standard QoS flow 1 and CAPC 2 of non-standard QoS flow 2, the UE determines CAPC 3 of the associated default bearer. Taking CAPC 1 taking a value of 1 and CAPC 2 taking a value of 2 as an example, determining the CAPC 3 of the associated default bearer includes at least one of the following manners.
(1) The value of CAPC 3 of the association default bearer is determined as the maximum value in the value of CAPC 1 and the value of CAPC 2.

For example, in a case where the maximum value in the value of CAPC 1 and the value of CAPC 2 is 2, then the value of CAPC 3 is 2.
(3) The value of CAPC 3 of the association default bearer is determined as the minimum value in the value of CAPC 1 and the value of CAPC 2.

For example, in a case where the minimum value in the value of CAPC 1 and the value of CAPC 2 is 1, then the value of CAPC 3 is 1.
(4) The value of CAPC 3 of the association default bearer is determined as any one of the value of CAPC 1 and the value of CAPC 2.

In some embodiments, the value of CAPC 3 is either 1 or 2.
(5) The value of CAPC 3 of the association default bearer is determined as an average value of the value of CAPC 1 and the value of CAPC 2.

The average value may be rounded up or down, for example, the rounded-up average value of the value of CAPC 1 and the value of CAPC 2 is 2, and in a case where the value of CAPC 3 is determined as the rounded-up average value, the value of CAPC 3 is 2; and the rounded-down average value of the value of CAPC 1 and the value of CAPC 2 is 1, and in a case where the value of CAPC 3 is determined as the rounded-down average value, the value of CAPC 3 is 1.
(6) The value of CAPC 3 of the association default bearer is determined as the value of the CAPC of the non-standard QoS flow with the minimum first parameter.

In some embodiments, the QoS parameter of non-standard QoS flow 1 includes the first parameter, and the QoS parameter of non-standard QoS flow 2 includes the first parameter.

In a case where the first parameter corresponding to non-standard QoS flow 1 is minimum, CAPC 1 of non-standard QoS flow 1 is determined as CAPC 3 of the associated default bearer.

In a case where the first parameter corresponding to non-standard QoS flow 2 is minimum, CAPC 2 of non-standard QoS flow 2 is determined as CAPC 3 of the associated default bearer. The first parameter includes at least one of the PDB, the DP, or the PER.

For example, in a case where the DP in the QoS parameter of non-standard QoS flow 1 takes a value of 1 and the DP in the QoS parameter of non-standard QoS flow 2 takes a value of 2, and 1 is less than 2, then the value of CAPC 3 is the value of CAPC 1 of non-standard QoS flow 1, i.e., CAPC 3 takes the value of 1.
(7) The value of CAPC 3 of the association default bearer is determined as the value of the CAPC of the corresponding non-standard QoS flow where the second parameter is of the first type.

In some embodiments, the QoS parameter of non-standard QoS flow 1 includes the second parameter, and the QoS parameter of non-standard QoS flow 2 includes the second parameter.

In a case where the second parameter corresponding to non-standard QoS flow 1 is of the first type, CAPC 1 of non-standard QoS flow 1 is determined as CAPC 3 of the associated default bearer.

In a case where the second parameter corresponding to non-standard QoS flow 2 is of the first type, CAPC 2 of the non-standard QoS flow is determined as CAPC 3 of the associated default bearer.

The second parameter includes at least one of the service type or the resource type.

The first type corresponding to the service type is the MCS, and the first type corresponding to the resource type is the DCGBR.

For example, in a case where the service type corresponding to non-standard QoS flow 1 is the MCS, the value of CAPC 3 of the association default bearer is the value of CAPC 1 of non-standard QoS flow 1, i.e., the value of CAPC 3 of the association default bearer takes the value of 1.

The above method may be configured by the network device or specified by the communication protocol or implemented based on the UE itself, and the UE dynamically determines CAPC 3 of the associated default bearer by the above method with the change of non-standard QoS flow 1 and non-standard QoS flow 2.

In some embodiments, in a case where the network device configures CAPC 3 of the associated default bearer, the network device may instruct the UE must to use CAPC 3 configured by the network device, or instruct the UE to determine autonomously based on the methods in the embodiments described above, or the UE may by default ignore CAPC 3 configured by the network device and determine autonomously.

In some embodiments, the UE maps similar non-standard QoS flows to a same RLC SDU/PDU, wherein the similar non-standard QoS flows are non-standard QoS flows with the same or similar CAPCs determined based on the method for determining the CAPC of the non-standard QoS flow described above. The similarity of the CAPCs means that the difference between the values of the CAPCs is less than the first range, wherein the first range is specified by a network device configuration or a communication protocol. The unprocessed data that enters each sublayer is referred to as the SDU, and the data that is processed by the sublayer to form a specific format is referred to as the PDU. The SDU at the N^{th} layer and the PDU at the (N−1)^{th} layer are one-to-one correspondence.

In a case where the non-standard QoS flows with the same CAPC value are mapped to the same RLC SDU/PDU, the UE determines the CAPC value of the RLC SDU/PDU to be that same CAPC value.

In a case where the non-standard QoS flows with different CAPC values are mapped to the same RLC SDU/PDU, the UE determines the CAPC value of the RLC SDU/PDU based on the principles of the above manner for determining the value of CAPC 3 of the associated default bearer.

In summary, by using the method according to these embodiments, the CAPC of a non-standard QoS flow is determined based on the QoS parameter of the non-standard QoS flow. In a case where the network does not provide the CAPC, the terminal determines the CAPC of the non-standard QoS flow, such that the tasks such as LBT monitoring, packet assembling, and the like are performed.

In addition, by using the method according to these embodiments, the CAPC of the associated default bearer of the non-standard QoS flow is determined based on the CAPC of the non-standard QoS flow. In a case where the network does not provide a CAPC, the terminal determines the CAPC of the associated default bearer of the non-standard QoS flow, such that the tasks such as LBT monitoring, packet assembling, and the like are performed.

Further, by using the method according to these embodiments, the CAPC of the associated RLC SDU/PDU of the non-standard QoS flow is determined based on the CAPC of the non-standard QoS flow. In a case where the network does not provide the CAPC, the terminal determines the CAPC of the associated RLC SDU/PDU of the non-standard QoS flow, such that the tasks such as LBT monitoring, packet assembling, and the like are performed.

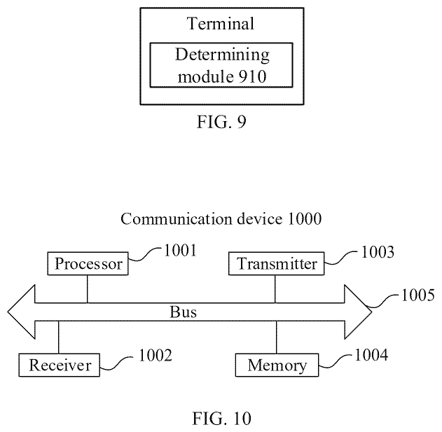

FIG. 9 is a block diagram of an apparatus for determining a CAPC according to some embodiments of the present disclosure. The apparatus includes a determining module 910.

The determining module 910 is configured to determine a CAPC of a first non-standard QoS flow.

In some embodiments, the determining module 910 is configured to determine the CAPC of the first non-standard QoS flow based on one or more QoS parameters of the first non-standard QoS flow.

In some embodiments, the determining module 910 is configured to determine the CAPC of the first non-standard QoS flow based on information configured by the network for the first non-standard QoS flow.

In some embodiments, the determining module 910 is configured to determine the CAPC of the first non-standard QoS flow based on implementation of the terminal.

In some embodiments, the determining module 910 is configured to determine the CAPC of the first non-standard QoS flow based on a parameter matching criterion satisfied by one QoS parameters of the first non-standard QoS flow.

In some embodiments, the determining module 910 is configured to determine the CAPC of the first non-standard QoS flow based on the number of parameters in the plurality of QoS parameters of the first non-standard QoS flow that satisfy a matching criterion, wherein the matching criterion is used to filter a QoS parameter corresponding to a first CAPC and the matching criterion includes a parameter matching criterion corresponding to each of the plurality of QoS parameters.

In some embodiments, the determining module 910 is configured to: determine the CAPC of the first non-standard QoS flow as the first CAPC in a case where the plurality of QoS parameters all satisfy the matching criterion; or determine the CAPC of the first non-standard QoS flow as the first CAPC in a case where the number of parameters in the plurality of QoS parameters that satisfy the matching criterion reaches a first number.

In some embodiments, the determining module 910 is configured to determine the CAPC of the first non-standard QoS flow as the first CAPC in a case where the number of parameters in the plurality of QOS parameters that satisfy the matching criterion is determined as reaching the first number based on priorities; wherein the priorities indicate a determination order of the plurality of QOS parameters.

In some embodiments, the parameter matching criterion includes at least one of: a value matching a target value; a value belonging to a target value range; a value type belonging to a target type; or a level which a value is closest to in different levels, wherein the different levels correspond to different CAPCs.

In some embodiments, the value matching the target value includes:
a value of a PDB matching the target value in a case where the one or more QoS parameters comprise the PDB;
a value of a DP matching the target value in a case where the one or more QoS parameters comprise the DP; and
a value of a PER matching the target value in a case where the one or more QoS parameters comprise the PER.

In some embodiments, the value matching the target value includes:
a value of a PDB matching the target value in a case where the one or more QoS parameters comprise the PDB;
a value of a DP matching the target value in a case where the one or more QoS parameters comprise the DP; and
a value of a PER matching the target value in a case where the one or more QoS parameters comprise the PER.

In some embodiments, the value type belonging to the target type includes:
a value type a service type belonging to the target type in a case where the one or more QoS parameters comprise the service type; and
a value type of a resource type belonging to the target type in a case where the one or more QoS parameters comprise the resource type.

In some embodiments, the level which the value is closest to in the different levels includes:
a level which a value of a PDB is closest to in the different levels in a case where the one or more QoS parameters comprise the PDB; and
a level which a value of a PER is closest to in the different levels in a case where the one or more QoS parameters comprise the PER.

In some embodiments, at least one of the target value, the target value range, the target type, or the level is determined by at least one of: network device configuration, or a communication protocol provision.

### Network Device Configuration.

### Communication Protocol Provisions.

In some embodiments, the one or more QoS parameters include at least one of: a PDB, a DP, a PER, a service type, or a resource type.

In some embodiments, the one or more QoS parameters are determined or selected by at least one of: network device configuration, a communication protocol provision, service type-based selection; or resource type-based selection.

In some embodiments, a state of the terminal when performing the method includes at least one of: an RRC connected state, an RRC idle state, an RRC inactive state, or an out-of-coverage state.

In some embodiments, the determining module 910 is further configured to determine a CAPC of an associated radio bearer of the first non-standard QoS flow based on the CAPC of the first non-standard QoS flow.

In some embodiments, the determining module 910 is configured to determine the CAPC of the associated radio bearer based on the CAPC of the first non-standard QoS flow and a CAPC of a second non-standard QoS flow, wherein the associated radio bearer is a radio bearer associated with the first non-standard QoS flow and the second non-standard QoS flow.

In some embodiments, the determining module 910 is configured to:
determine a maximum value in the CAPC of the first non-standard QoS flow and the CAPC of the second non-standard QoS flow as the CAPC of the associated radio bearer; or
determine a minimum value in the CAPC of the first non-standard QoS flow and the CAPC of the second non-standard QoS flow as the CAPC of the associated radio bearer; or
determine any one of the CAPC of the first non-standard QoS flow and the CAPC of the second non-standard QoS flow as the CAPC of the associated radio bearer; or
determine an average value of the CAPC of the first non-standard QoS flow and the CAPC of the second non-standard QoS flow as the CAPC of the associated radio bearer.

In some embodiments, the determining module 910 is configured to: determine the CAPC of the first non-standard QoS flow as the CAPC of the associated radio bearer in a case where a first parameter corresponding to the first non-standard QoS flow is minimum; or determine the CAPC of the second non-standard QoS flow as the CAPC of the associated radio bearer in a case where a first parameter corresponding to the second non-standard QoS flow is minimum. A QoS parameter of the first non-standard QoS flow includes the first parameter, and a QoS parameter of the second non-standard QoS flow includes the first parameter.

In some embodiments, the determining module 910 is configured to: determine the CAPC of the first non-standard QoS flow as the CAPC of the associated radio bearer in a case where a second parameter corresponding to the first non-standard QoS flow is of a first type; or determine the CAPC of the second non-standard QoS flow as the CAPC of the associated radio bearer in a case where a second parameter corresponding to the second non-standard QoS flow is of a first type. A QoS parameter of the first non-standard QoS flow includes the second parameter, and a QoS parameter of the second non-standard QoS flow includes the second parameter.

In some embodiments, the associated radio bearer includes a default radio bearer.

In some embodiments, the determining module 910 is further configured to determine a CAPC of an associated RLC PDU/SDU of the first non-standard QoS flow based on the CAPC of the first non-standard QoS flow.

In some embodiments, the determining module 910 is configured to determine the CAPC of the associated RLC PDU/SDU based on the CAPC of the first non-standard QoS flow and a CAPC of a second non-standard QoS flow, wherein the associated RLC PDU/SDU is an RLC PDU/SDU associated with the first non-standard QoS flow and the second non-standard QoS flow.

In some embodiments, the determining module 910 is configured to:
determine a maximum value in the CAPC of the first non-standard QoS flow and the CAPC of the second non-standard QoS flow as the CAPC of the associated RLC PDU/SDU; or
determine a minimum value in the CAPC of the first non-standard QoS flow and the CAPC of the second non-standard QoS flow as the CAPC of the associated RLC PDU/SDU; or
determine any one of the CAPC of the first non-standard QoS flow and the CAPC of the second non-standard QoS flow as the CAPC of the associated RLC PDU/SDU; or
determine an average value of the CAPC of the first non-standard QoS flow and the CAPC of the second non-standard QoS flow as the CAPC of the associated RLC PDU/SDU.

In some embodiments, the determining module 910 is configured to: determine the CAPC of the first non-standard QoS flow as the CAPC of the associated RLC PDU/SDU in a case where a third parameter corresponding to the first non-standard QoS flow is minimum; or determine the CAPC of the second non-standard QoS flow as the CAPC of the associated RLC PDU/SDU in a case where a third parameter corresponding to the second non-standard QoS flow is minimum. A QoS parameter of the first non-standard QoS flow includes the third parameter, and a QoS parameter of the second non-standard QoS flow includes the third parameter.

In some embodiments, the determining module 910 is configured to: determine the CAPC of the first non-standard QoS flow as the CAPC of the associated RLC PDU/SDU in a case where a fourth parameter corresponding to the first non-standard QoS flow is of a second type; or determine the CAPC of the second non-standard QoS flow as the CAPC of the associated RLC PDU/SDU in a case where a fourth parameter corresponding to the second non-standard QoS flow is of a second type. A QoS parameter of the first non-standard QoS flow includes the fourth parameter, and a QoS parameter of the second non-standard QoS flow includes the fourth parameter.

In some embodiments, the determining module 910 is configured to: map the first non-standard QoS flow and the second non-standard QoS flow having a same CAPC to a same RLC PDU/SDU, and determine a CAPC of the RLC PDU/SDU.

In some embodiments, the determining module 910 is configured to: map the first non-standard QoS flow and the second non-standard QoS flow having similar CAPCs to a same RLC PDU/SDU, and determine a CAPC of the RLC PDU/SDU, wherein the similar CAPCs are CAPCs where a difference between CAPC values is less than a first range.

FIG. 10 is a schematic structural diagram of a communication device 1000 according to some embodiments of the present disclosure. The communication device 1000 includes a processor 1001, a receiver 1002, a transmitter 1003, a memory 1004, and a bus 1005.

The processor 1001 includes one or more processing cores. The processor 1001 runs various functional applications and performs information processing by running software programs and modules.

The receiver 1002 and the transmitter 1003 may be implemented as one communication assembly. The communication assembly may be a communication chip, which may also be referred to as a transceiver.

The memory 1004 is connected to the processor 1001 via the bus 1005.

The memory 1004 may be configured to store at least one computer program. The processor 1001 is configured to load and run the at least one computer program to perform the processes in the above method embodiments.

In addition, the memory 1004 may be implemented using any type of volatile or non-volatile storage device or a combination thereof. The volatile or non-volatile storage device includes but is not limited to: a magnetic disk or an optical disc, an electrically erasable programmable read-only memory (EEPROM), an erasable programmable read-only memory (EPROM), a static random access memory (SRAM), a read-only memory (ROM), a magnetic memory, a flash memory, or a programmable ROM (PROM).

In some embodiments, the processor in the communication device is configured to determine a CAPC of a first non-standard QoS flow.

In some embodiments, the transceiver in the communication device is configured to transmits/receives a CAPC of a first non-standard QoS flow.

In some embodiments, the processor in the communication devices configured to determine a CAPC of an associated radio bearer of a first non-standard QoS flow based on a CAPC of the first non-standard QoS flow.

In some embodiments, the processor in the communication devices configured to determine a CAPC of an associated RLC PDU/SDU of a first non-standard QoS flow based on a CAPC of the first non-standard QoS flow.

The embodiments of the present disclosure further provide a non-transitory computer-readable storage medium. The non-transitory computer-readable storage medium stores at least one instruction, at least one program, or a code set or instruction set, and the at least one instruction, the at least one program, or the code set or instruction set, when loaded and run by a processor, causes the processor to perform the method for determining CAPCs according to each of the above embodiments.

The present disclosure further provides a computer program product. The computer program product, when running on a processor of a computer device, causes the computer device to perform the method for determining CAPCs according to each of the above embodiments.

It is understandable to the person of ordinary skill in the art that all or part of the processes for realizing the above embodiments may be implemented by hardware, or may be implemented by hardware instructed by a program, wherein the program may be stored in a non-transitory computer-readable storage medium. The non-transitory storage medium may be a ROM, a magnetic disk, an optical disc, or the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described are merely embodiments of the present disclosure and are not intended to limit the present disclosure. Any modifications, equivalent replacements, improvements, and the like, made within the spirit and principle of the present disclosure shall fall within the protection scope of the present disclosure.

1. A method for determining channel access priority classes (CAPCs), applicable to a terminal, the method comprising:
determining a CAPC of a first non-standard quality of service (QOS) flow.

2. The method according to claim 1, wherein determining the CAPC of the first non-standard QoS flow comprises at least one of:
determining the CAPC of the first non-standard QoS flow based on one or more QoS parameters of the first non-standard QoS flow;
determining the CAPC of the first non-standard QoS flow based on information configured by a network for the first non-standard QoS flow; or
determining the CAPC of the first non-standard QoS flow based on implementation of the terminal.

3. The method according to claim 2, wherein determining the CAPC of the first non-standard QoS flow based on one QoS parameter of the first non-standard QoS flow comprises:
determining the CAPC of the first non-standard QoS flow based on a parameter matching criterion satisfied by one QoS parameter of the first non-standard QoS flow.

4. The method according to claim 2, wherein determining the CAPC of the first non-standard QoS flow based on a plurality of QOS parameters of the first non-standard QoS flow comprises:
determining the CAPC of the first non-standard QoS flow as the first CAPC in a case where the plurality of QoS parameters all satisfy the matching criterion; or
determining the CAPC of the first non-standard QoS flow as the first CAPC in a case where the number of parameters in the plurality of QOS parameters that satisfy a matching criterion is determined as reaching a first number based on priorities;
wherein the matching criterion is used to filter a QoS parameter corresponding to a first CAPC, and the matching criterion comprises a parameter matching criterion corresponding to each of the plurality of QoS parameters, and the priorities indicate a determination order of the plurality of QoS parameters.

5. The method according to claim 3, wherein the parameter matching criterion comprises at least one of:
a value matching a target value;
a value belonging to a target value range;
a value type belonging to a target type; or
a level which a value is closest to in different levels, wherein the different levels correspond to different CAPCs, and the closest level is a value of a standard QoS flow.

6. The method according to claim 5, wherein the value matching the target value comprises at least one of:
a value of a packet delay budget (PDB) matching the target value in a case where the one or more QoS parameters comprise the PDB; a value of a default priority (DP) matching the target value in a case where the one or more QoS parameters comprise the DP; or a value of a packet error rate (PER) matching the target value in a case where the one or more QoS parameters comprise the PER;
wherein the value belonging to the target value range comprises at least one of:
a value of a PDB belonging to the target value range in a case where the one or more QoS parameters comprise the PDB; or a value of a PER belonging to the target value range in a case where the one or more QoS parameters comprise the PER; and
the value type belonging to the target type comprises at least one of:
a value type of a service type belonging to the target type in a case where the one or more QoS parameters comprise the service type; or a value type of a resource type belonging to the target type in a case where the one or more QoS parameters comprise the resource type.

7. The method according to claim 5, wherein the level which the value is closest to in the different levels comprises at least one of:
a level which a value of a packet delay budget (PDB) is closest to in the different levels in a case where the one or more QoS parameters comprise the PDB; or
a level which a value of a packet error rate (PER) is closest to in the different levels in a case where the one or more QoS parameters comprise the PER.

8. The method according to claim 5, wherein at least one of the target value, the target value range, the target type, or the level is determined by at least one of:
network device configuration; or
a communication protocol provision.

9. The method according to claim 2, wherein the one or more QoS parameters comprise at least one of: a packet delay budget (PDB), a default priority (DP), a packet error rate (PER), a service type, or a resource type; and
wherein the one or more QoS parameters are determined or selected by at least one of: network device configuration, a communication protocol provision, service type-based selection, or resource type-based selection.

10. The method according to claim 1, wherein a state of the terminal when performing the method comprises at least one of:
a radio resource control (RRC) connected state;
an RRC idle state;
an RRC inactive state; or
an out-of-coverage state.

11. The method according to claim 1, further comprising:
determining a CAPC of an associated radio bearer based on the CAPC of the first non-standard QoS flow and a CAPC of a second non-standard QoS flow, wherein the associated radio bearer is a radio bearer associated with the first non-standard QoS flow and the second non-standard QoS flow.

12. The method according to claim 11, wherein determining the CAPC of the associated radio bearer based on the CAPC of the first non-standard QoS flow and the CAPC of the second non-standard QoS flow comprises one of:
determining a maximum value in the CAPC of the first non-standard QoS flow and the CAPC of the second non-standard QoS flow as the CAPC of the associated radio bearer;
determining a minimum value in the CAPC of the first non-standard QoS flow and the CAPC of the second non-standard QoS flow as the CAPC of the associated radio bearer;
determining any one of the CAPC of the first non-standard QoS flow and the CAPC of the second non-standard QoS flow as the CAPC of the associated radio bearer; or
determining an average value of the CAPC of the first non-standard QoS flow and the CAPC of the second non-standard QoS flow as the CAPC of the associated radio bearer.

13. The method according to claim 11, wherein the associated radio bearer comprises a default radio bearer.

14. A communication device, comprising:
a processor;
a transceiver, connected to the processor; and
a memory, configured to store one or more executable instructions, which when executed by the processor, causes the communication device to:
determine a channel access priority class (CAPC) of a first non-standard quality of service (QoS) flow.

15. The communication device according to claim 14, wherein the one or more executable instructions, which when executed by the processor, further causes the communication device to:
determine the CAPC of the first non-standard QoS flow based on one or more QoS parameters of the first non-standard QoS flow;
determine the CAPC of the first non-standard QoS flow based on information configured by a network for the first non-standard QoS flow; or
determine the CAPC of the first non-standard QoS flow based on implementation of the terminal.

16. The communication device according to claim 15, wherein the one or more executable instructions, which when executed by the processor, further causes the communication device to:
determining the CAPC of the first non-standard QoS flow based on a parameter matching criterion satisfied by one QoS parameter of the first non-standard QoS flow.

17. The communication device according to claim 16, wherein the parameter matching criterion comprises at least one of:
a value matching a target value;
a value belonging to a target value range;
a value type belonging to a target type; or
a level which a value is closest to in different levels, wherein the different levels correspond to different CAPCs, and the closest level is a value of a standard QoS flow.

18. The communication device according to claim 17, wherein the level which the value is closest to in the different levels comprises at least one of:
a level which a value of a packet delay budget (PDB) is closest to in the different levels in a case where the one or more QoS parameters comprise the PDB; or
a level which a value of a packet error rate (PER) is closest to in the different levels in a case where the one or more QoS parameters comprise the PER.

19. The communication device according to claim 17, wherein at least one of the target value, the target value range, the target type, or the level is determined by at least one of:
network device configuration; or
a communication protocol provision.

20. A non-transitory computer-readable storage medium, storing one or more computer programs, which when executed by a processor, causes the processor to:
determine a channel access priority class (CAPC) of a first non-standard quality of service (QOS) flow.
